(19) United States
(12) Patent Application Publication
(10) Pub. No.: US 2009/0290138 A1
(43) Pub. Date: Nov. 26, 2009

(54) PULSE MOTOR, POSITIONING APPARATUS, EXPOSURE APPARATUS, AND DEVICE MANUFACTURING METHOD

(75) Inventor: Mitsuya Sato, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/467,666

(22) Filed: May 18, 2009

(30) Foreign Application Priority Data
May 20, 2008 (JP) 2008-132359

(51) Int. Cl. G03B 27/58; H02K 41/03

(52) U.S. Cl. 355/72; 310/12.17; 310/12.06

(57) ABSTRACT

A pulse motor includes a first element in which a plurality of convex portions are arranged cyclically, and a second element disposed to face the first element. The plurality of convex portions include first and second convex portions. The first convex portion forms a part of a first magnetic circuit including a portion passing a magnetic flux along a first direction. The second convex portion forms a part of a second magnetic circuit including a portion passing a magnetic flux along a second direction. The second element includes first and second coils to apply a magnetic flux to the first and second magnetic circuit. A time duration in which the movable element moves includes a time duration in which a timing at which a current flowing through the first coil is maximum and a timing at which a current flowing through the second coil is maximum appear alternately.

### BACKGROUND OF THE INVENTION

1. Field of the Invention

The present invention relates to a pulse motor, a positioning apparatus, an exposure apparatus, and a device manufacturing method.

2. Description of the Related Art

FIG. 7A is a sectional view showing the sectional structure of a linear pulse motor. FIG. 7B is a view showing the configuration of the lower surface (the surface facing a stationary element) of a movable element of a plane pulse motor. The movable element shown in FIG. 7B can be configured by arranging movers as shown in FIG. 7A. FIG. 8 is a perspective view showing a stage mechanism which incorporates a plane pulse motor including the movable element shown in FIG. 7B.

A stationary element (stator) 1 includes a plurality of convex portions 2 containing a magnetic material, and a concave portion 3 is formed between adjacent convex portions 2. The concave portion 3 means a magnetically insulated portion, and is generally filled with, for example, a resin. A movable element 4 includes a plurality of magnetic blocks 11 to 16. Tooth tops 51 to 56 are formed on the plurality of magnetic blocks 11 to 16 in correspondence with the three-dimensional pattern of the stationary element 1. Coils 61 to 66 are wound around the plurality of magnetic blocks 11 to 16, respectively. Permanent magnets 81, 82, and 83 are interposed between the magnetic blocks 11 and 12, 13 and 14, and 15 and 16, respectively. The permanent magnets 81, 82, and 83 generate bias magnetic fluxes.

A plurality of movers 6 for driving the movable element 8 in the X direction, and a plurality of movers 7 for driving the movable element 8 in the Y direction are arranged on a movable element 8. The movers 6 and 7 can have a configuration as shown in FIG. 7A. Air outlet ports 5 are formed in the lower surface (the surface facing the stationary element 1) of the movable element 8. By blowing air from the air outlet port 5, the movable element 8 is levitated from the stationary element 1 and can move in this state.

FIGS. 9A and 9B are views schematically showing thrusts generated by the pulse motor shown in FIGS. 7A and 7B. FIG. 10A is a graph showing changes in currents supplied to the coils of the pulse motor shown in FIGS. 7A and 7B. FIG. 10B is a graph showing a change in magnetic flux in the pulse motor shown in FIGS. 7A and 7B.

For the sake of descriptive convenience, FIGS. 9A and 9B show one tooth top exemplifying four tooth tops formed on each magnetic block shown in FIG. 7A. A U-phase current 91, V-phase current 92, and W-phase current 93 flow through the coils 62, 64, and 66, respectively, as shown in FIG. 10A. Currents that are in opposite phase with those flowing through the coils 62, 64, and 66 flow through the coils 61, 63, and 65. FIG. 9A shows the state at a timing A shown in FIG. 10A, and FIG. 9B shows the state at a timing B shown in FIG. 10A. The magnitudes and directions of the currents flowing through the coils 61 to 66 are indicated by arrows on their right sides.

Referring to FIG. 9A, the currents flow through the coils 61 and 62 in the direction in which they strengthen a bias magnetic flux generated by the permanent magnet 81. Because the tooth tops 51 and 52 are located above the convex portions 2 of the stationary element 1, they are strongly held at their current positions. In contrast, at this time, the currents flow through the coils 63 to 66 in the direction in which they weaken bias magnetic fluxes generated by the permanent magnets 82 and 83. Because only parts of the convex portions 2 are present under the tooth tops 53 to 56, they are held at their current positions with small forces.

When the phases of the currents flowing through these coils advance by 600 from the state shown in FIG. 9A to that shown in FIG. 10A as in the timing B, the magnetic fluxes generated by the currents change as shown in FIG. 9B. More specifically, the forces which hold the tooth tops 51 and 52 at their current positions weaken upon decreases in the currents flowing through the coils 61 and 62. In contrast, at this time, the currents flow through the coils 63 and 64 in the direction in which they strengthen a bias magnetic flux generated by the permanent magnet 82. For this reason, the movable element 4 generates a thrust so as to move itself to the left side relative to the stationary element 1.

In a stationary element 1 of a plane pulse motor as shown in FIG. 8, convex portions 2 are cyclically arranged in the X and Y directions at a predetermined interval, and the size ratio between convex and concave portions 2 and 3 is typically about 1:1. For this reason, the passage area of magnetic fluxes which flow from tooth tops of movers into the convex portions 2 of the stationary element 1 is about 25% the area of the stationary element 1. This configuration has low magnetic flux use efficiency, making it difficult to produce a high thrust.

In addition, a movable element 4 of a conventional pulse motor controls the thrust by synthesizing a bias magnetic flux 96 generated by a permanent magnet with a magnetic flux 95 generated by a coil, as shown in FIG. 10B. The bias magnetic flux 96 can typically have a magnitude several times that of the magnetic flux 95 generated by the coil. This is because if the bias magnetic flux is relatively weak, vibration in the pitching direction often occurs during movement of the movable element in response to a temporal change in a position at which the magnetic attraction force is maximal.

An internal magnetic flux 98 that is determined depending on a bias magnetic flux and a magnetic flux generated by a coil needs to be suppressed below a saturation magnetic flux 97 that is determined depending on the structure of a pulse motor and the saturation magnetic flux density of a magnetic material used in the pulse motor. For this reason, a current to flow through the coil of the conventional pulse motor cannot be increased above a certain limit, making it difficult to produce a high thrust.

### SUMMARY OF THE INVENTION

The present invention improves the thrust of, for example, a pulse motor.

One of the aspect of the present invention provides a pulse motor which includes a first element in which a plurality of convex portions containing a magnetic material are arranged cyclically, and a second element disposed to face the first element, one of the first element and the second element being configured to function as a movable element and the other of the first element and the second element being configured to function as a stationary element, wherein the plurality of convex portions include a plurality of first convex portions and a plurality of second convex portions, the first convex portion forming a part of a first magnetic circuit including a first portion which passes a magnetic flux along a first direction, and the second convex portion forming a part of a second magnetic circuit including a second portion which passes a magnetic flux along a second direction, the second element includes a first coil to apply a magnetic flux to the first magnetic circuit, and a second coil to apply a magnetic flux to the second magnetic circuit, and a time duration in which the movable element moves includes a time duration in which a timing at which a current flowing through the first coil is maximum and a timing at which a current flowing through the second coil is maximum appear alternately.

Further features of the present invention will become apparent from the following description of exemplary embodiments with reference to the attached drawings.

### BRIEF DESCRIPTION OF THE DRAWINGS

FIG. 1 is a perspective view showing the partial configuration of a pulse motor according to a preferred embodiment of the present invention;

FIG. 2A is a view showing the partial configuration of the pulse motor according to the preferred embodiment of the present invention;

FIG. 2B is a view showing the partial configuration of the pulse motor according to the preferred embodiment of the present invention;

FIG. 3A is a view showing the configuration of the surface (the surface facing a movable element) of a stationary element of the pulse motor according to the preferred embodiment of the present invention;

FIG. 3B is a view showing the internal configuration of the stationary element of the pulse motor according to the preferred embodiment of the present invention;

FIG. 4A is a view showing the structure of constituent elements of the stationary element and a method of manufacturing the stationary element;

FIG. 4B is a view showing the structure of constituent elements of the stationary element and the method of manufacturing the stationary element;

FIG. 4C is a view showing the structure of constituent elements of the stationary element and the method of manufacturing the stationary element;

FIG. 5 is a graph illustrating coil current control in the pulse motor according to the preferred embodiment of the present invention;

FIG. 6 is a graph showing changes in magnetic fluxes generated by coils in the pulse motor according to the preferred embodiment of the present invention vs. those in a magnetic flux generated by a coil in the conventional pulse motor;

FIG. 7A is a sectional view showing the sectional structure of a linear pulse motor;

FIG. 7B is a sectional view showing the sectional structure of the linear pulse motor;

FIG. 8 is a perspective view showing a stage mechanism which incorporates a plane pulse motor including the movable element shown in FIG. 7B;

FIG. 9A is a view schematically showing a thrust generated by the pulse motor shown in FIGS. 7A and 7B;

FIG. 9B is a view schematically showing a thrust generated by the pulse motor shown in FIGS. 7A and 7B;

FIG. 10A is a graph showing changes in currents supplied to coils of the pulse motor shown in FIGS. 7A and 7B;

FIG. 10B is a graph showing a change in magnetic flux in the pulse motor shown in FIGS. 7A and 7B;

FIG. 11 is a view illustrating the shapes of convex portions of a stationary element according to the first application example of the present invention;

FIG. 12 is a view illustrating the shapes of convex portions of a stationary element according to the second application example of the present invention;

FIG. 13 is a perspective view showing the third application example of the present invention;

FIG. 14 is a perspective view showing the fourth application example of the present invention;

FIG. 15A is a view showing the fifth application example of the present invention;

FIG. 15B is a view showing the fifth application example of the present invention;

FIG. 15C is a view showing the fifth application example of the present invention; and

FIG. 16 is a view schematically showing the arrangement of a positioning apparatus and exposure apparatus according to a preferred embodiment of the present invention.

### DESCRIPTION OF THE EMBODIMENTS

Preferred embodiments of the present invention will be described below with reference to the accompanying drawings.

In a preferred embodiment of the present invention, a pulse motor includes a movable element and stationary element. The movable element can move relative to the stationary element, and the stationary element can move relative to the movable element. The definition as to whether an element which constitutes a pulse motor is a movable element or a stationary element can change depending on the application purpose of the pulse motor. From this viewpoint, unless the application purpose of a pulse motor is specified, a first element and a second element appropriately express elements which constitute the pulse motor rather than a movable element and a stationary element. The second element is disposed to face the first element. One of the first element and the second element functions as a movable element, and the other functions as a stationary element.

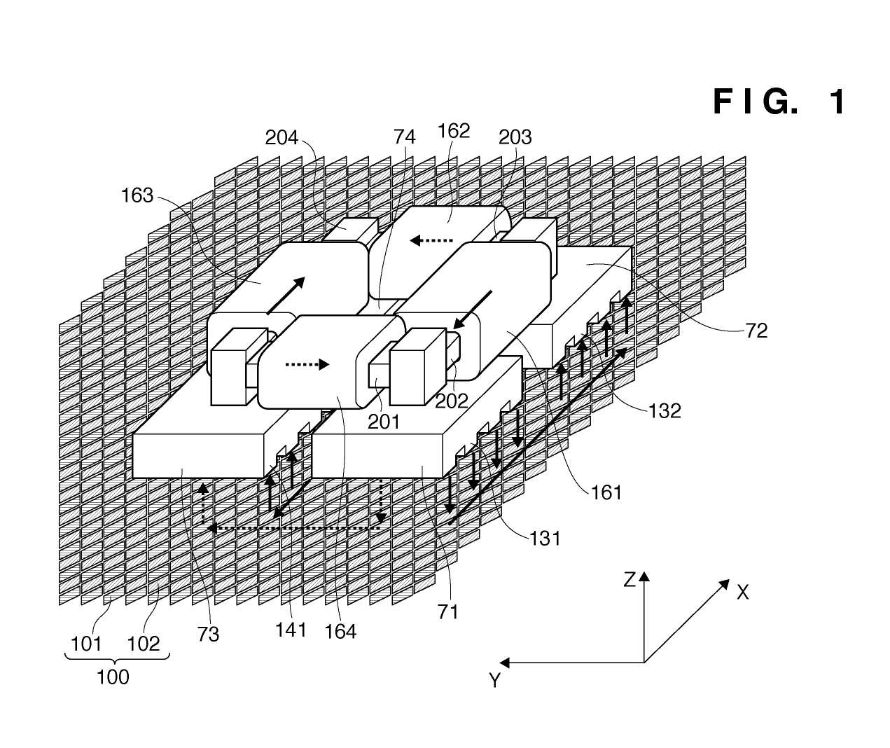

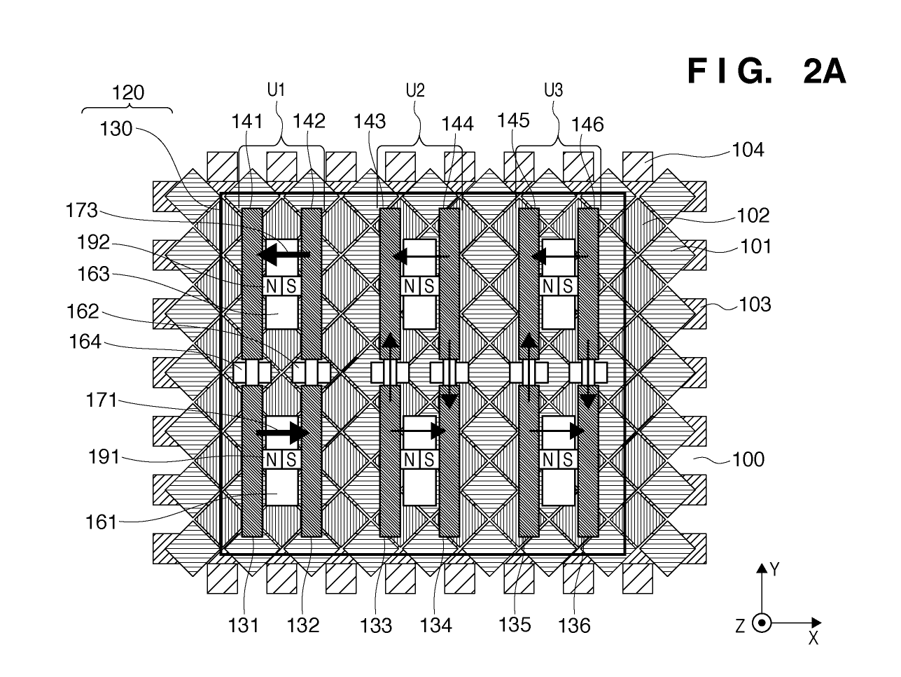

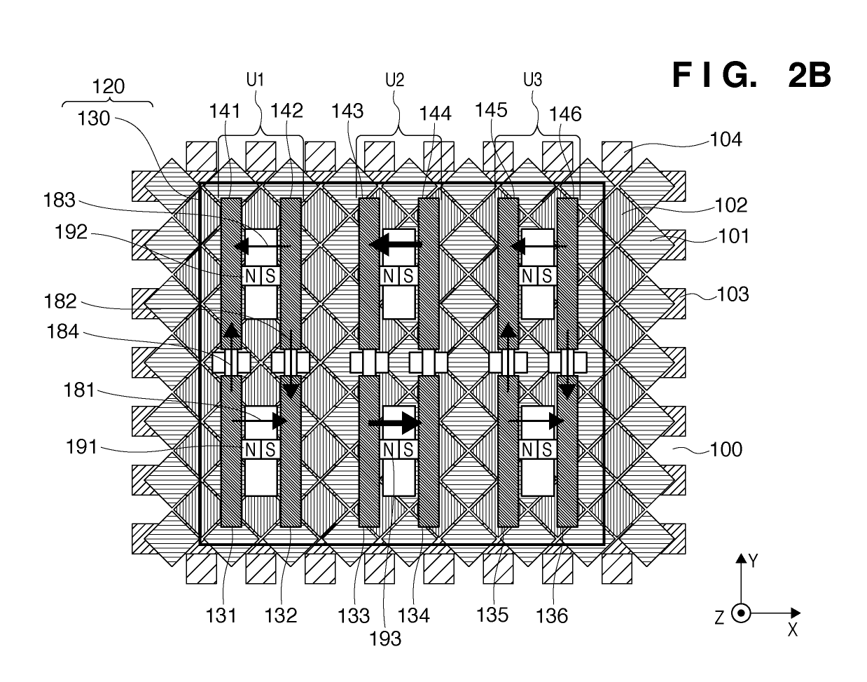

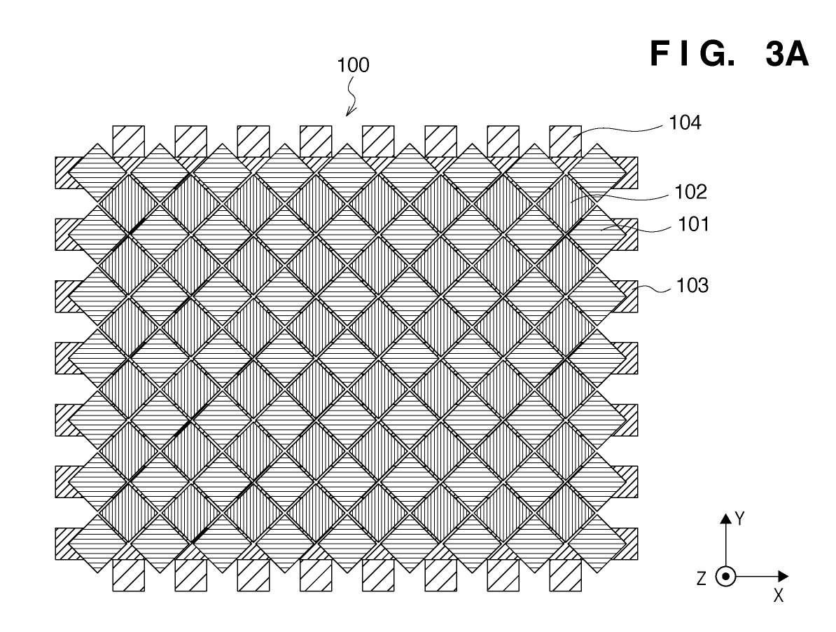

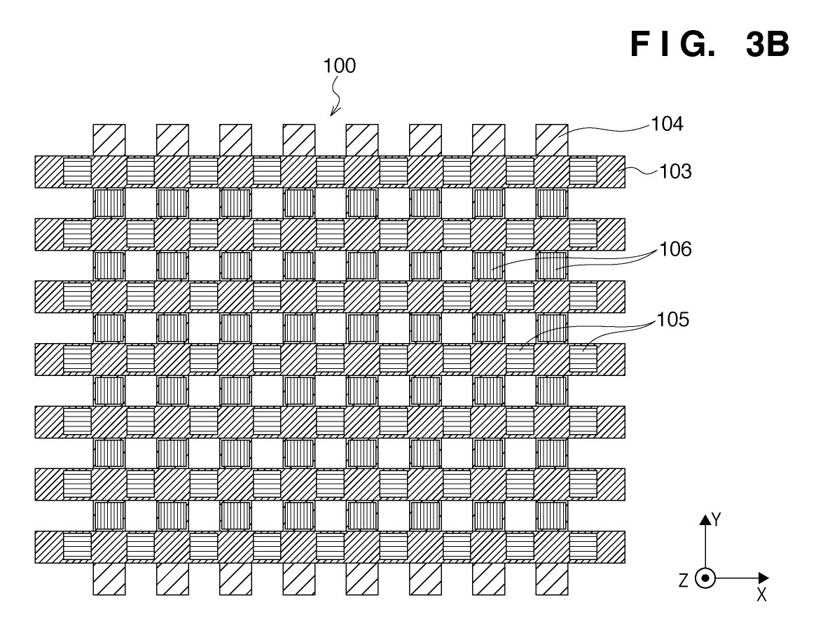

FIG. 1 is a perspective view showing the partial configuration of a pulse motor according to a preferred embodiment of the present invention. FIGS. 2A and 2B are views showing the partial configuration of the pulse motor according to the preferred embodiment of the present invention. Note that for the sake of descriptive convenience, FIGS. 2A and 2B show one tooth top (e.g., a tooth top 131) exemplifying four tooth tops (e.g., tooth tops 131) formed on each magnetic block shown in FIG. 1. FIG. 3A is a view showing the configuration of the surface (the surface facing a movable element) of a stationary element of the pulse motor according to the preferred embodiment of the present invention. FIG. 3B is a view showing the internal configuration of the stationary element of the pulse motor according to the preferred embodiment of the present invention.

The pulse motor according to this embodiment includes a stationary element (stator) 100 serving as one element in which a plurality of convex portions containing a magnetic material are cyclically arranged in the X direction (first direction) and the Y direction (second direction), and a movable element 120 serving as another element disposed to face the stationary element 100.

The plurality of convex portions of the stationary element 100 includes a plurality of X-direction convex portions (first convex portions) 101, and a plurality of Y-direction convex portions (second convex portions) 102. Each of the X-direction convex portions (first convex portions) 101 forms a part of a first magnetic circuit 230 including an X-direction magnetic flux passing portion (first portion) 103 which passes a magnetic flux along the X direction (first direction). Each of the plurality of Y-direction convex portions (second convex portions) 102 forms a part of a second magnetic circuit 240 including a Y-direction magnetic flux passing portion (second portion) 104 which passes a magnetic flux along the Y direction (second direction).

The movable element 120 includes at least one mover 130. Note that the mover 130 includes units U1, U2, and U3 corresponding to three phases in FIGS. 2A and 2B, and FIG. 1 shows the unit U1, corresponding to one phase alone, of the units U1, U2, and U3 corresponding to three phases. Details common to the units U1, U2, and U3 will be explained by taking the unit U1 as an example.

The units U1, U2, and U3 are set at spatial positions spaced apart from each other by one third of the arrangement cycle of the convex portions of the stationary element 100. Accordingly, currents supplied to coils of the units U1, U2, and U3 are one third of the period out of phase with each other.

The unit U1 includes a plurality of magnetic blocks. The unit U1 includes, for example, a first magnetic block 71, second magnetic block 72, third magnetic block 73, and fourth magnetic block 74. The first, second, third, and fourth magnetic blocks 71, 72, 73, and 74 have tooth tops 131, 132, 141, and 142, respectively, which face the stationary element 100. The unit U2 includes first, second, third, and fourth magnetic blocks having tooth tops 133, 134, 143, and 144, respectively, which face the stationary element 100, as in the unit U1. The unit U3 includes first, second, third, and fourth magnetic blocks having tooth tops 135, 136, 145, and 146, respectively, which face the stationary element 100, as in the unit U1.

The unit U1 of the mover 130 generates a thrust by generating a magnetic flux and moves relative to the stationary element 100. The mover 130 includes X-direction coils (first coils) 161 and 163 to apply a magnetic flux to the first magnetic circuit 230, and Y-direction coils (second coils) 162 and 164 to apply a magnetic flux to the second magnetic circuit 240. The plurality of magnetic blocks 71, 72, 73, and 74 apply the magnetic flux generated by the X-direction coils (first coils) 161 and 163 to the first magnetic circuit 230, and apply the magnetic flux generated by the Y-direction coils (second coils) 162 and 164 to the second magnetic circuit 240.

Note that the first magnetic block 71 and the third magnetic block 73 are connected by a first connecting member 201 containing a magnetic material, and are juxtaposed in the Y direction (second direction). The second magnetic block 72 and the fourth magnetic block 74 are connected by a third connecting member 203 containing a magnetic material, and are juxtaposed in the Y direction (second direction). The first magnetic block 71 and the second magnetic block 72 are connected by a second connecting member 202 containing a magnetic material, and are juxtaposed in the X direction (first direction). The third magnetic block 73 and the fourth magnetic block 74 are connected by a fourth connecting member 204 containing a magnetic material, and are juxtaposed in the X direction (first direction). The Y-direction coils (second coils) include coils 164 and 162 wound around the first connecting member 201 and the third connecting member 203, respectively. The X-direction coils (first coils) include coils 161 and 163 wound around the second connecting member 202 and the fourth connecting member 204, respectively.

The time duration in which the movable element 120 moves includes the time duration in which a timing at which currents flowing through the X-direction coils (first coils) 161 and 163 are maximal and that at which currents flowing through the Y-direction coils (second coils) 162 and 164 are maximum appear alternately. The moving direction of the movable element 120 is determined depending on the configuration of the mover 130, more specifically, the arrangement of the units U1, U2, and U3 and the tooth top arrangement. In the arrangements shown in FIGS. 1, 2A, and 2B, the movable element 120 moves in the X direction. If the pulse motor is configured as a plane pulse motor, the movable element 120 includes a mover which generates a thrust in the X direction, and that which generates a thrust in the Y direction. If the pulse motor is configured as a linear motor, the movable element 120 includes one of a mover which generates a thrust in the X direction, and that which generates a thrust in the Y direction.

A case in which the first direction corresponds to the X direction, and the second direction corresponds to the Y direction has been described above. The first direction and the second direction are preferably orthogonal each other as in this case, but need not be orthogonal to each other.

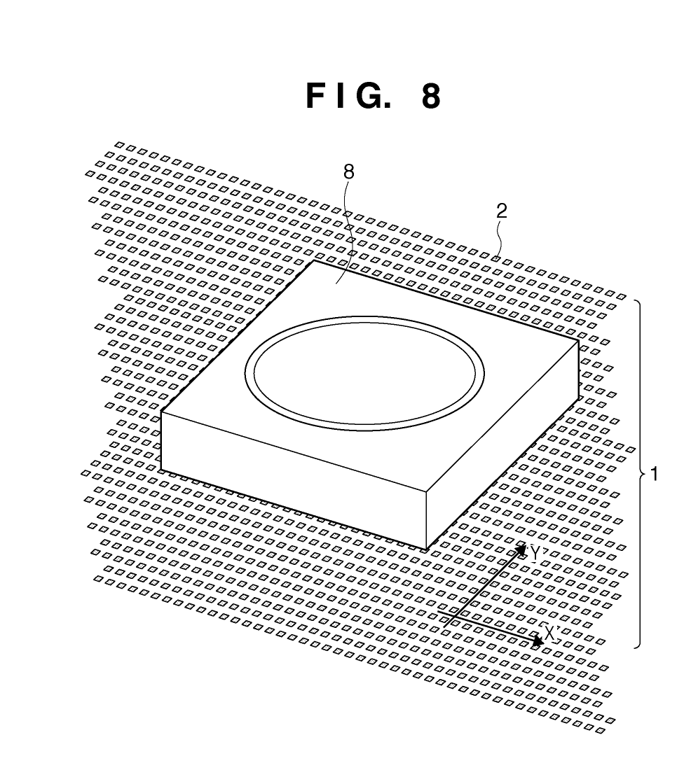

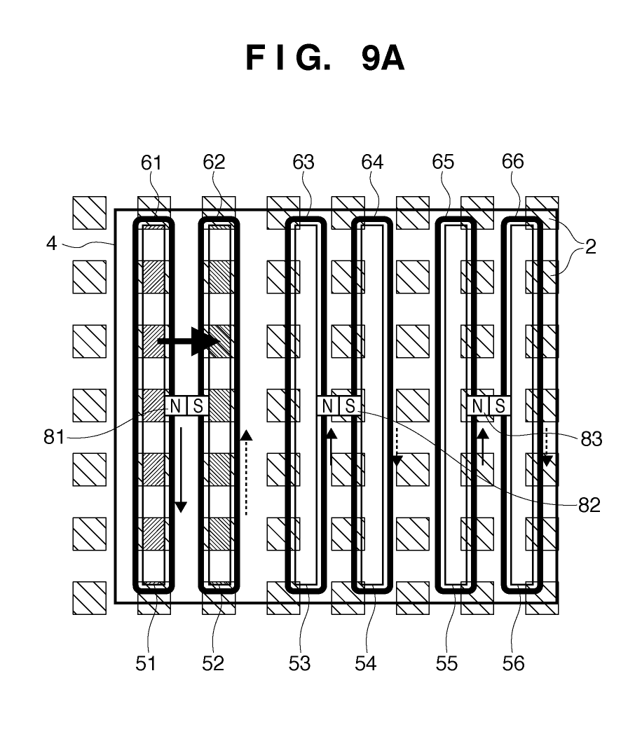

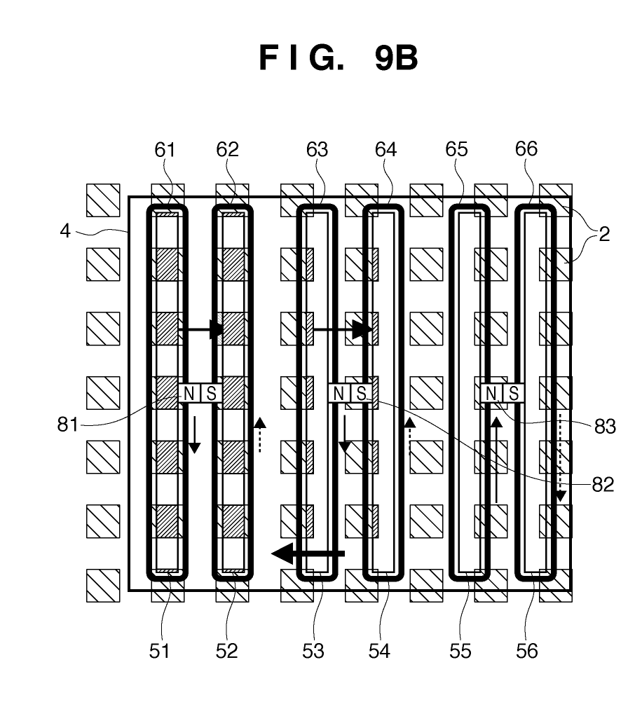

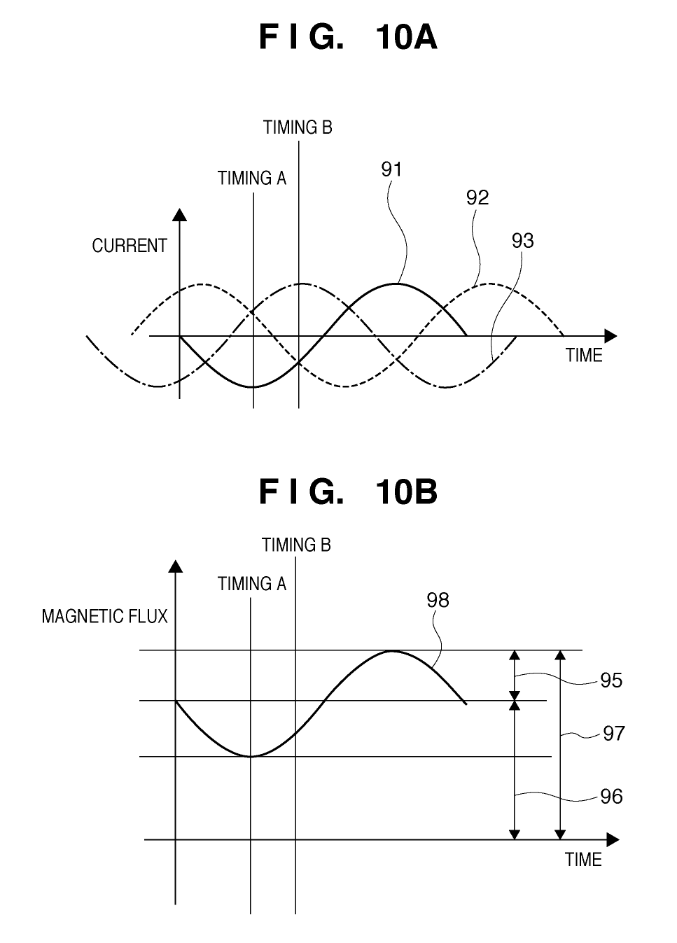

Each of the plurality of convex portions (the plurality of X-direction convex portions 101 and the plurality of Y-direction convex portions 102) preferably has a shape in which its dimensions in the Y direction (second direction) are different from each other in at least at two positions on a straight line along the X direction (first direction). A preferable example of the shape in which its dimensions in the Y direction are different from each other in at least at two positions on a straight line along the X direction (first direction) is a configuration in which a line which defines the outer shape of each convex portion forms an angle of 45° with the X and Y directions, as shown in FIG. 3A. The plurality of X-direction convex portions 101 and the plurality of Y-direction convex portions 102 are preferably arranged in a checkerboard pattern. With a configuration as shown in FIG. 3A, the ratio of the convex portions to the entire stationary element 100 can be nearly 100 percent. In contrast, in a configuration as illustrated in FIG. 8, the ratio of the convex portions to the entire stationary element 100 is about 25 percent.

A permanent magnet 191 is interposed between the first magnetic block 71 having the tooth top 131 and the second magnetic block 72 having the tooth top 132. The permanent magnet 191 can be the whole or a part of the second connecting member 202. A permanent magnet 192 is interposed between the third magnetic block 73 having the tooth top 141 and the fourth magnetic block 74 having the tooth top 142. The permanent magnet 192 can be the whole or a part of the fourth connecting member 204.

Note that permanent magnets 191 and 192 are not necessary for the generation of a thrust but is provided for the generation of bias magnetic fluxes. That is, permanent magnets 191 and 192 are provided to prevent the position of the mover 130 from becoming unstable while the coils 161 to 164 are OFF.

The stationary element 100 is configured such that the convex portions of the stationary element 100 are present under all tooth tops of the movable element 120. With this configuration, all tooth tops contribute to generate thrusts at all timings. This minimizes temporal changes in a position at which the magnetic attraction force is maximal, unlike the conventional plane pulse motor. This makes it possible to stably move the movable element 120 even upon reducing bias magnetic fluxes generated by the permanent magnets. Hence, magnetic fluxes which contribute to generate a thrust can be increased by increasing currents supplied to the coils. This improves the thrust of the pulse motor.

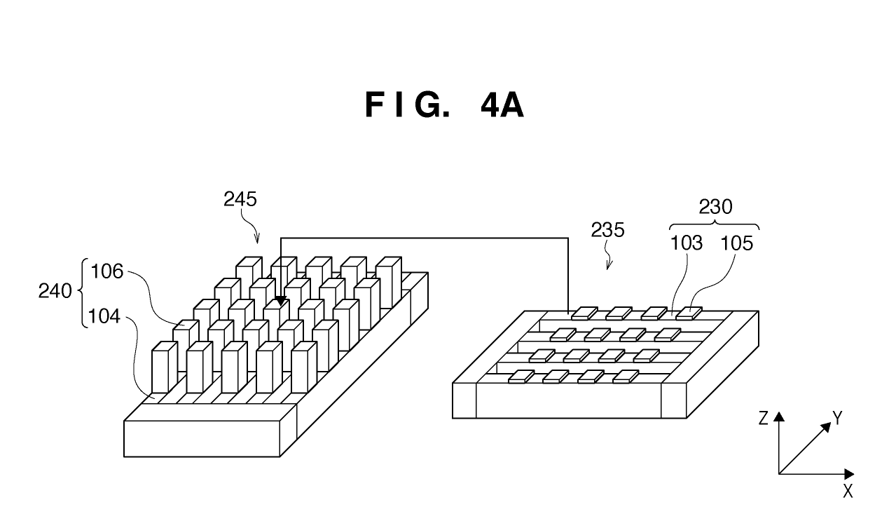

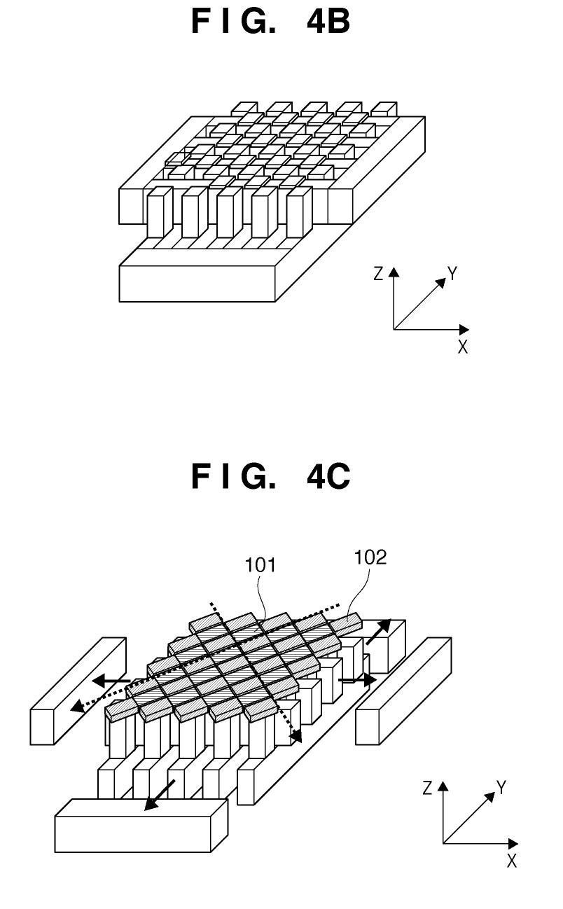

The structure of the stationary element 100 and a method of manufacturing the stationary element 100 will be explained with reference to FIGS. 3A, 3B, and 4A to 4C. FIG. 3B shows the stationary element 100, from which the X-direction convex portions 101 and the Y-direction convex portions 102 are omitted, when viewed from above. FIGS. 4A to 4C show the structure of constituent elements of the stationary element 100 and a method of manufacturing the stationary element 100.

The first magnetic circuit 230 contains a magnetic material, and includes an X-direction magnetic flux passing portion (first portion) 103 which passes a magnetic flux along the X-direction, and a first support unit 105 which supports the X-direction convex portions 101 and passes a magnetic flux along the Z-direction. A first support unit 105 is unnecessary if X-direction convex portions 101 are formed directly on the X-direction magnetic flux passing portion (first portion) 103. The second magnetic circuit 240 contains a magnetic material, and includes a Y-direction magnetic flux passing portion (second portion) 104 which passes a magnetic flux along the Y-direction, and a second support unit 106 which supports the Y-direction convex portions 102 and passes a magnetic flux along the Z-direction. It is also possible to reverse the configurations of the first magnetic circuit 230 and second magnetic circuit 240.

An exemplary method of manufacturing a stationary element 100 will be explained below. First, a first magnetic circuit group 235 formed by connecting a plurality of first magnetic circuits 230, as illustrated in FIG. 4A, is extracted from a material block containing a magnetic material. In addition, a second magnetic circuit group 245 formed by connecting a plurality of second magnetic circuits 240, as illustrated in FIG. 4A, is extracted from a material block containing a magnetic material.

Next, as shown in FIG. 4B, the first magnetic circuit group 235 and the second magnetic circuit group 245 are assembled such that they are not in magnetic contact with each other.

Lastly, as shown in FIG. 4C, a plate member containing a magnetic material is bonded on a first support unit 105 and a second support unit 106, and the plate member is divided to form X-direction convex portions 101 and Y-direction convex portions 102 arranged in a checkerboard pattern, as indicated by broken lines. After that, a resin can be supplied into the gaps between the X-direction convex portions 101 and the Y-direction convex portions 102. The surface of a stationary element 100 including the X-direction convex portions 101 and Y-direction convex portions 102 undergoes, for example, grinding, thereby finishing the stationary element 100.

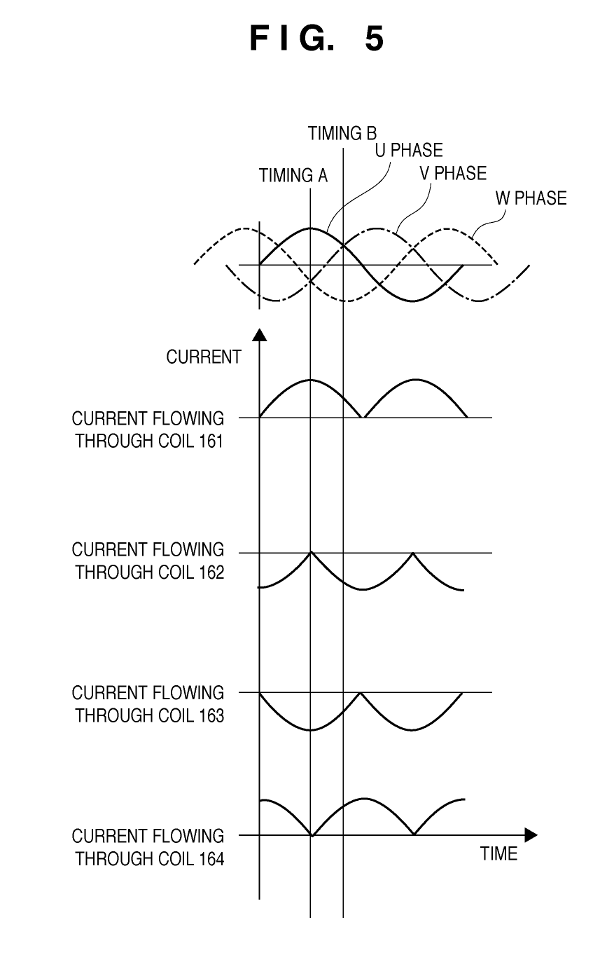

FIG. 5 is a graph illustrating coil current control in the pulse motor according to the preferred embodiment of the present invention. A driving circuit (not shown) supplies currents which temporally change to the coils 161, 162, 163, and 164, as shown in FIG. 5. Note that although direct currents can also be supplied to the coils 161, 162, 163, and 164 in driving the movable element 120 in order to cancel bias magnetic fluxes generated by the permanent magnets 191 and 192, these currents are not shown in FIG. 5 for the sake of descriptive simplicity.

The internal magnetic fluxes of the stationary element 100 at timings A and B shown in FIG. 5, and thrusts generated by them will be exemplified below.

FIG. 2A shows the internal magnetic flux of the stationary element 100 at the timing A shown in FIG. 5. Referring to FIG. 2A, arrows (e.g., arrows 171 and 173) indicate magnetic fluxes. As is obvious from FIG. 5, maximum currents flow through the coils 161 and 163 at the timing A. For this reason, two very strong magnetic loops are formed in the stationary element 100 at the timing A. One magnetic loop comes from the tooth top 131, runs through the X-direction convex portions 101 and X-direction magnetic flux passing portions 103 of the stationary element 100, and reaches the tooth top 132. The other magnetic loop comes from the tooth top 142, runs through the X-direction convex portions 101 and X-direction magnetic flux passing portions 103 of the stationary element 100, and reaches the tooth top 141.

Also at the timing A, no currents flow through the coils 162 and 164, so no magnetic loops are formed between the tooth tops 131 and 141, and 132 and 142. For this reason, the magnetic loops running through the X-direction convex portions 101 cause the unit U1 having the tooth tops 131, 132, 141, and 142 to strongly hold these tooth tops at their current positions at which the magnetic flux passage area in the X direction is maximal.

A current that is one third of the period out of phase with that which flows through each coil of the unit U1 having the tooth tops 131, 132, 141, and 142 flows through the corresponding coil of the unit U2 having the tooth tops 133, 134, 143, and 144. Hence, a magnetic flux as shown in FIG. 2A runs through these coils. Because the areas of the tooth tops 133, 134, 143, and 144 located above the Y-direction convex portions 102 are larger than those of the tooth tops 133, 134, 143, and 144 located above the X-direction convex portions 101, the unit U2 having the tooth tops 133, 134, 143, and 144 generates a rightward thrust and attraction force which increase the magnetic flux passage area in the Y direction.

A current that is two thirds of the period out of phase with that which flows through each coil of the unit U1 having the tooth tops 131, 132, 141, and 142 flows through the corresponding coil of the unit U3 having the tooth tops 135, 136, 145, and 146. Hence, a magnetic flux as shown in FIG. 2A runs through these coils. Because the areas of the tooth tops 135, 136, 145, and 146 located above the Y-direction convex portions 102 are larger than those of the tooth tops 135, 136, 145, and 146 located above the X-direction convex portions 101, the unit U3 having the tooth tops 135, 136, 145, and 146 generates a leftward thrust and attraction force which increase the magnetic flux passage area in the Y-direction.

Note that a rightward thrust generated by the unit U2 having the tooth tops 133, 134, 143, and 144 and a leftward thrust generated by the unit U3 having the tooth tops 135, 136, 145, and 146 cancel each other. Hence, the movable element 120 holds the tooth tops at their current positions relative to the stationary element 100 and generates an attraction force to it.

FIG. 2B shows the internal magnetic flux of the stationary element 100 at the timing B shown in FIG. 5. Referring to FIG. 2B, arrows (e.g., arrows 181 to 184) indicate magnetic fluxes. At the timing B, the unit U1 having the tooth tops 131, 132, 141, and 142 has changed from the state in which the first magnetic circuits including the X-direction convex portions 101 alone are used to that in which both the first magnetic circuits including the X-direction convex portions 101 and the second magnetic circuits including the Y-direction convex portions 102 are used. Hence, the unit U1 maintains an attraction force to the stationary element 100 but has a weaker force which has been strongly holding the tooth tops at their then current positions.

The unit U2 has the tooth tops 133, 134, 143, and 144. The unit U2 has changed from the state in which both the first magnetic circuits including the X-direction convex portions 101 and the second magnetic circuits including the Y-direction convex portions 102 are used to the state in which the first magnetic circuits including the X-direction convex portions 101 alone are used (the state in which very strong magnetic loops are formed). Hence, the unit U2 having the tooth tops 133, 134, 143, and 144 generate a leftward thrust and attraction force which increase the magnetic flux passage area in the X-direction.

Because the areas of the tooth tops 135, 136, 145, and 146 located above the Y-direction convex portions 102 are larger than those of the tooth tops 135, 136, 145, and 146 located above the X-direction convex portions 101, the unit U3 having the tooth tops 135, 136, 145, and 146 generates a leftward thrust and attraction force which increase the magnetic flux passage area in the Y-direction.

Although the generation of thrusts at two timings A and B has been explained herein, actual thrusts are almost continuously generated by all tooth tops by continuously changing the ratio between currents supplied to respective coils.

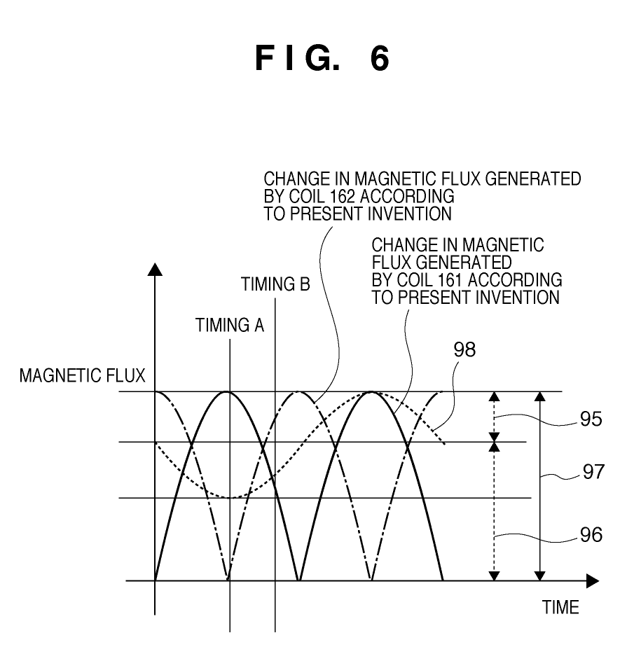

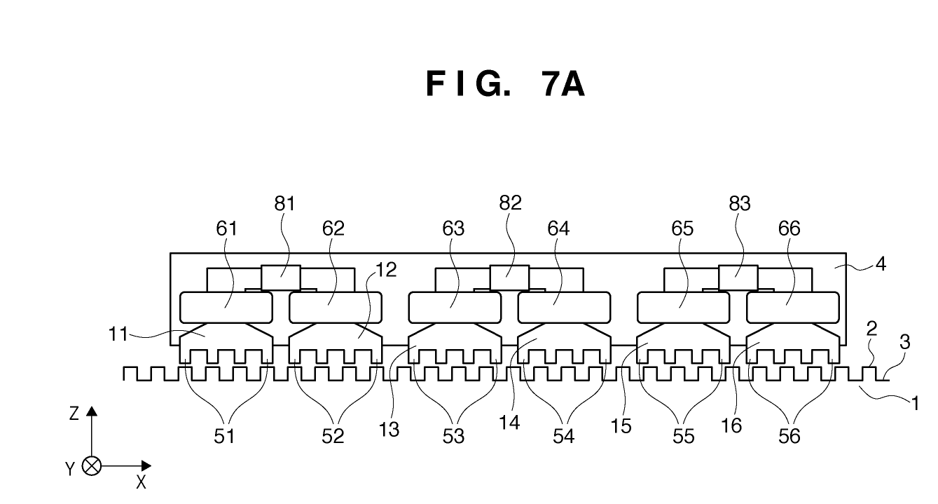

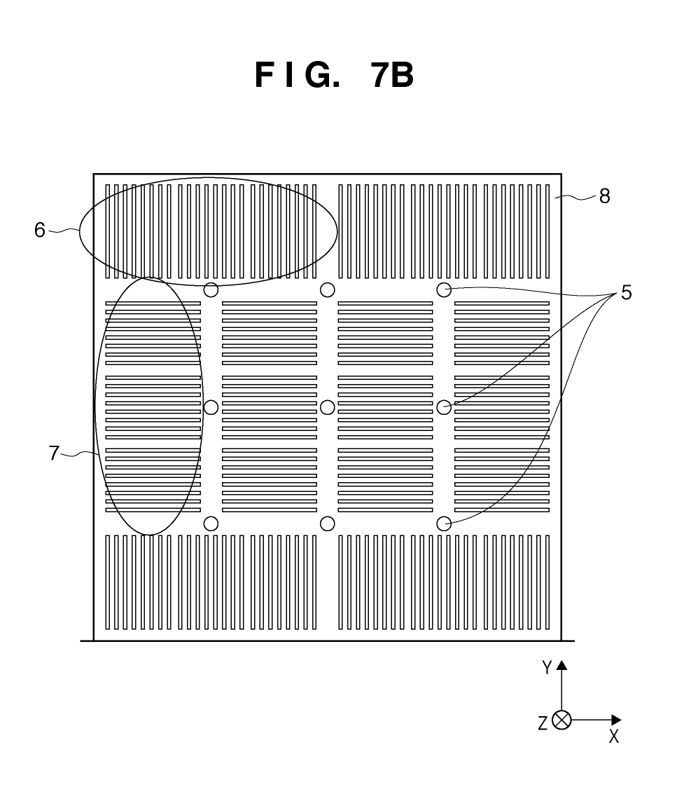

FIG. 6 shows changes in magnetic fluxes generated by coils in the pulse motor according to the preferred embodiment of the present invention vs. those in a magnetic flux generated by a coil in the conventional pulse motor. As is obvious from FIG. 6, a change in magnetic flux inside the movable element of the pulse motor according to the preferred embodiment of the present invention, especially, changes in magnetic fluxes at tooth tops can be enormously increased by reducing bias magnetic fluxes generated by permanent magnets. In other words, since the pulse motor according to the preferred embodiment of the present invention continuously, enormously changes the magnetic fluxes at all tooth tops, it can generate a great thrust as compared to the conventional pulse motor.

The magnitude of a current supplied to each coil of the movable element 120 is controlled in accordance with the phase angle of the current supplied to each coil of the movable element 120 and the moving speed of the movable element 120 so that the gap between the stationary element 100 and the movable element 120 stays constant. During standby of the pulse motor and during slow-speed movement of the movable element 120, the current value of each coil can be set small to save power.

The widths (the dimensions in a direction perpendicular to the moving direction of the movable element 120) of all tooth tops of the movable element 120 can be set (integer+0.5) times the cycle of the convex portions of the stationary element 100. The intervals between the tooth tops 131 to 136 and 141 to 146 can be set to be an integer multiple of the cycle of the convex portions of the stationary element 100. This setting is effective to suppress the generation of a thrust in a direction perpendicular to the moving direction of the movable element 120 during its movement.

Alternatively, the widths (the dimensions in a direction perpendicular to the moving direction of the movable element 120) of all tooth tops of the movable element 120 may be set to be an integer multiple of the cycle of the convex portions of the stationary element 100. Also, the intervals between the tooth tops 131 to 136 and 141 to 146 may be set (integer+0.5) times the cycle of the convex portions of the stationary element 100.

A sensor for measuring the gap between the movable element and the stationary element may be provided to control the amplitude of the current value of each coil.

Magnetic fluxes generated by the permanent magnets of the movable element may be strengthened to cancel the magnetic fluxes of the permanent magnets by currents flowing through the coils.

Exemplary application examples of the present invention will be explained below.

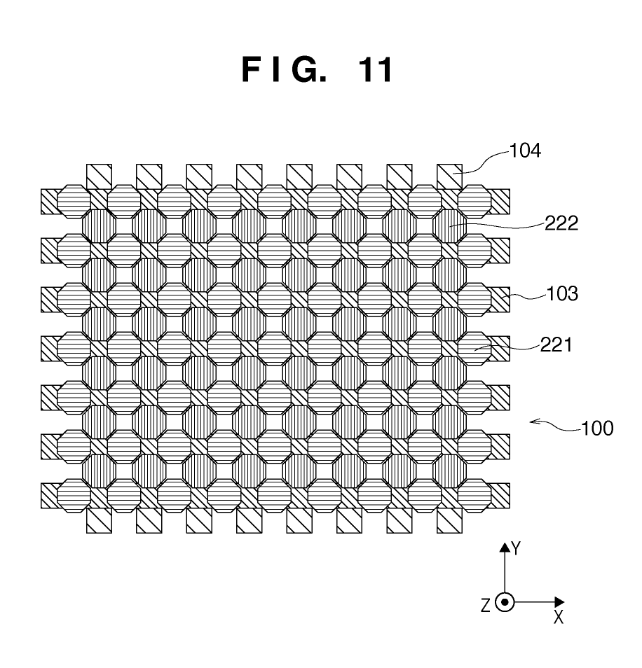

FIG. 11 is a view illustrating the shapes of convex portions of a stationary element 100 according to the first application example of the present invention. In the application example shown in FIG. 11, the stationary element 100 includes a plurality of X-direction convex portions (first convex portions) 221 and a plurality of Y-direction convex portions (second convex portions) 222. The plurality of X-direction convex portions (first convex portions) 221 and the plurality of Y-direction convex portions (second convex portions) 222 are arranged in a checkerboard pattern. The plurality of X-direction convex portions (first convex portions) 221 and the plurality of Y-direction convex portions (second convex portions) 222 have an octagonal shape.

Such a shape can reduce the length of a portion in which the X-direction convex portions (first convex portions) 221 and the Y-direction convex portions (second convex portions) 222 face each other through, for example, a resin. This produces the effect of reducing leakage magnetic fluxes between the X-direction convex portions 221 and the Y-direction convex portions 222. Moreover, at the stage of manufacturing a stationary element, since such a shape allows a large number of gaps to exist between the X-direction convex portions 221 and the Y-direction convex portions 222, a resin or the like can be easily supplied into them.

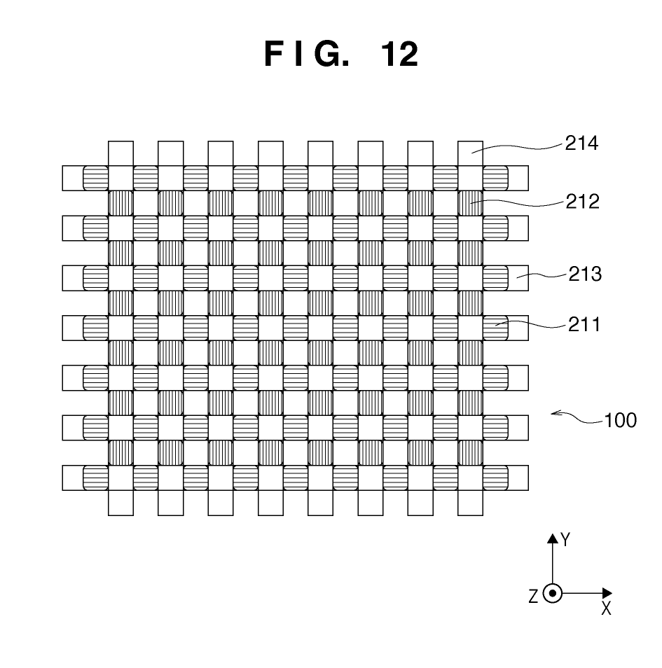

FIG. 12 is a view illustrating the shapes of convex portions of a stationary element 100 according to the second application example of the present invention. The stationary element 100 includes a plurality of X-direction convex portions (first convex portions) 211 and a plurality of Y-direction convex portions (second convex portions) 212. The plurality of X-direction convex portions (first convex portions) 211 and the plurality of Y-direction convex portions (second convex portions) 212 are arranged in a checkerboard pattern. The plurality of X-direction convex portions (first convex portions) 211 and the plurality of Y-direction convex portions (second convex portions) 212 have a square shape. Each side of the square is parallel to the X- or Y-direction.

The ratio of the magnetic flux passage area (the ratio of the area of the convex portions to that of the stationary element 100) in the second application example is about half (i.e., 50%) that (100%) in the configuration example shown in FIGS. 2A and 3A. However, this application example is excellent in ease of manufacture of a stationary element.

The manufacture of such a stationary element is effective in simplifying the manufacturing processes and reducing costs involved because there is no need to perform the step shown in FIG. 4C after the step shown in FIG. 4B.

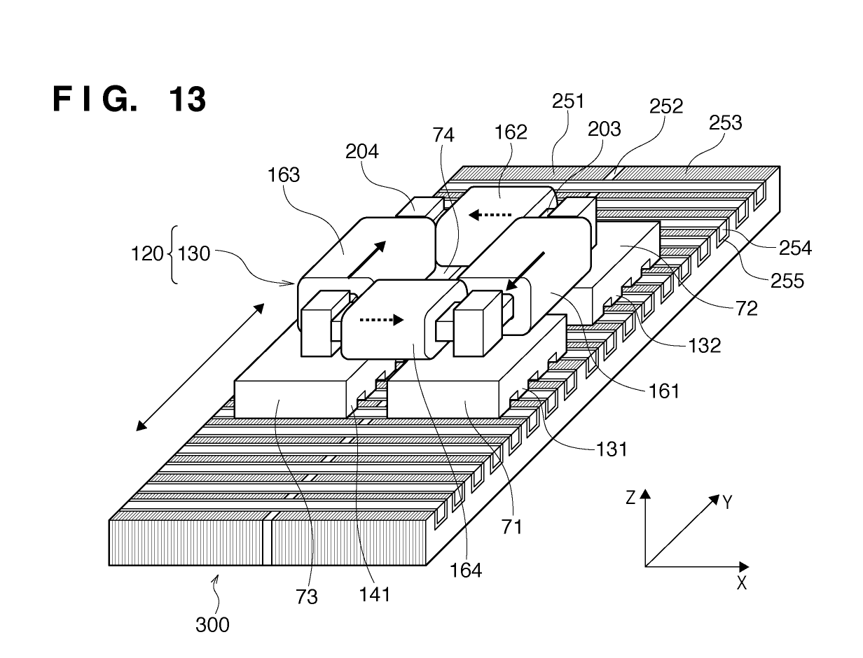

FIG. 13 is a perspective view showing the third application example of the present invention. The third application example is an example in which the pulse motor according to the present invention is applied to a linear pulse motor. The linear pulse motor includes a stationary element 300 in which a plurality of convex portions containing a magnetic material are arranged cyclically, and a movable element 120 disposed to face the stationary element 300. The movable element 120 has a configuration similar to that in the example shown in FIG. 1.

The plurality of convex portions of the stationary element 300 include a plurality of X-direction convex portions (first convex portions) 254 and a plurality of Y-direction convex portions (second convex portions) 251 and 253. Each of the X-direction convex portions 254 forms a part of a first magnetic circuit including a first portion which passes a magnetic flux along the X direction (first direction). Each of the Y-direction convex portions (second convex portions) 251 and 253 forms a part of a second magnetic circuit including a second portion which passes a magnetic flux along the Y direction (second direction).

The convex portions 251 and 253 are separated by a magnetoresistive layer 252 along the Y direction. In the third application example, X-direction convex portions 254 are cyclically arranged in a region where useless concave portions are formed in the conventional linear motor. Hence, the thrust of the pulse motor can be improved by using the stationary element 300 according to the third application example in combination with the movable element 120. Note that the time duration in which the movable element 120 moves includes the time duration in which a timing at which currents flowing through X-direction coils (first coils) are maximum and that at which currents flowing through Y-direction coils (second coils) are maximal appear alternately.

In this application example as well, the convex portions of the stationary element 300 always exist under all tooth tops 131, 132, 141, and 142 of the movable element 120, making it possible to continuously generating thrusts by them. It is therefore possible to considerably reduce bias magnetic fluxes generated by permanent magnets and strengthen coil current magnetic fluxes by the amounts of reduction, thus greatly improving the thrust of the pulse motor.

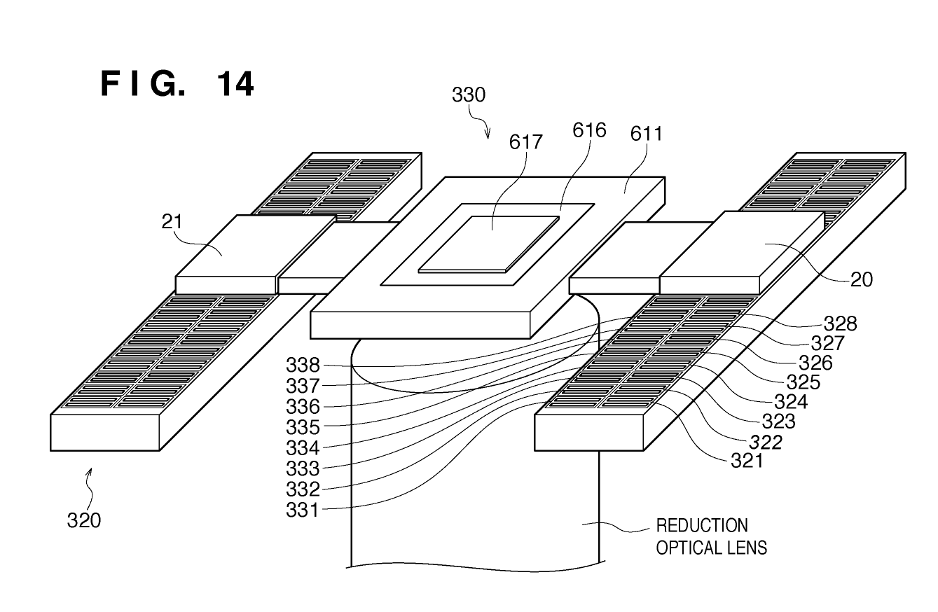

FIG. 14 is a perspective view showing the fourth application example of the present invention. The fourth application example is an example in which the pulse motor according to the present invention is applied to a linear pulse motor of an original positioning mechanism. In the fourth application example, convex portions are arranged on movers 20 and 21 of a movable element 330, and coils and tooth tops to be excited by them are arranged on a stationary element 320. The original positioning mechanism positions an original (reticle) and is incorporated in an exposure apparatus which projects the pattern of an original onto a substrate to expose the substrate. The movable element 330 includes a fine moving stage 616 which holds an original 617 and finely adjusts the position of the original 617, a coarse moving stage 611 which holds the fine moving stage 616, and two movers 20 and 21 connected to the coarse moving stage 611. The stationary element 320 includes coils 321 to 328 and 331 to 338 which generate magnetic fluxes. In the fourth application example, members obtained by reducing the length of the stationary element 300 in the third application example shown in FIG. 13 are used as movers 20 and 21, and a member obtained by arranging a large number of movers 130 in the third application example is used as a stationary element 320. In the fourth application example, it is possible to form movers 20 and 21 with a simple structure so as to have a light weight, and, therefore, to drive the original 617 at a high speed.

The coils 321, 322, 331, and 332 are disposed to excite a magnetic block. Likewise, the coils 323, 324, 333, and 334 are disposed to excite a magnetic block. These magnetic blocks are disposed to be spaced apart from each other by one third of the cycle of convex portions (not shown) of the movers 20 and 21.

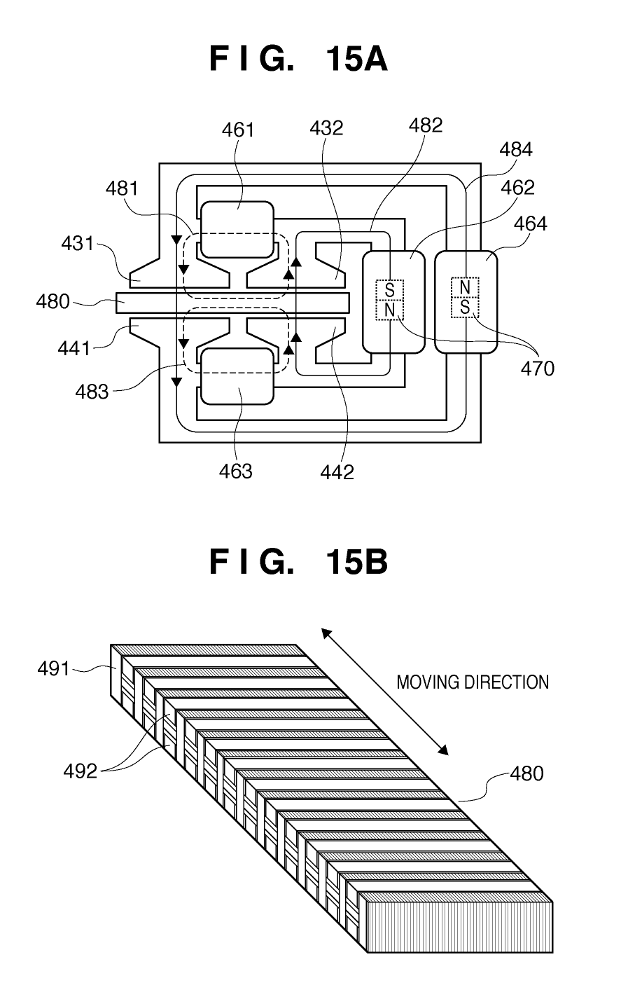

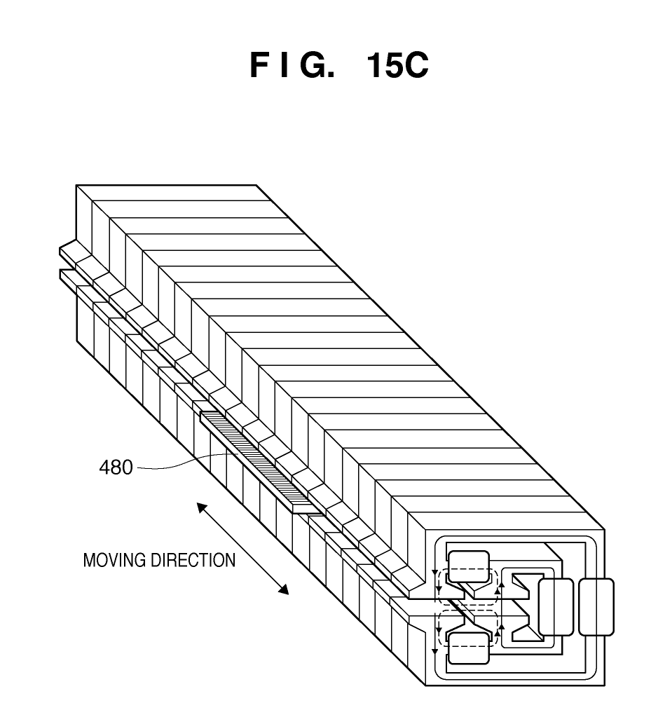

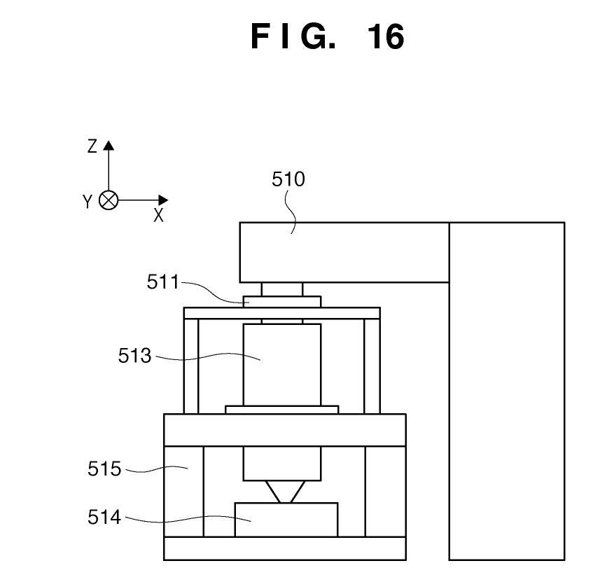

FIGS. 15A to 15C are views showing the fifth application example of the present invention. The fifth application example is an example in which the thrust of the linear pulse motor according to the fourth application example is further improved. A stationary element includes tooth tops 431, 432, 441, and 442, coils 461 to 464, and a permanent magnet 470. A movable element includes a mover 480. The mover 480 includes vertical magnetic flux passing blocks 491 and horizontal magnetic flux passing blocks 492. The coils 461 to 464 generate magnetic fluxes 481 to 484.

In the fifth application example, coils are arranged on the side of the stationary element, as in the fourth application example. The feature of the fifth application example lies in that all magnetic fluxes which pass through the interior of the mover run perpendicularly to its moving direction.

In the fifth application example, each unit of the stationary element temporally, alternately generates magnetic fluxes 481 to 484 in the vertical and horizontal directions by the coils 461 to 464 in the mover 480, as shown in FIG. 15A. In the stationary element, units having a configuration as shown in FIG. 15A are juxtaposed in the moving direction of the mover, as shown in FIG. 15C, and a unit in which the mover 480 has arrived generates a magnetic flux.

In the fifth application example, the mover 480 has a configuration in which vertical magnetic flux passing blocks 491 which pass a magnetic flux in the vertical direction alone and horizontal magnetic flux passing blocks 492 which pass a magnetic flux in the horizontal direction alone are arranged cyclically, as shown in FIG. 15B. With this configuration, the mover 480 generates a thrust in the direction shown in FIGS. 15B and 15C upon temporally, alternately receiving magnetic fluxes in the vertical and horizontal directions from a plurality of units.

According to the fifth application example, it is possible to reduce the length of the mover in its moving direction, thus downsizing the mover and, in turn, downsizing the entire configuration (linear pulse motor). Moreover, the thrust of the pulse motor improves by minimizing the internal magnetic resistance of the mover. Because coils can be vertically disposed in the stationary element, the mounting and cooling of the coils are further facilitated.

FIG. 16 is a view schematically showing the arrangement of a positioning apparatus and exposure apparatus according to a preferred embodiment of the present invention. The exposure apparatus includes an original positioning mechanism 511 which positions an original (reticle), an illumination system 510 which illuminates the original, a substrate positioning mechanism 514 which positions a substrate (wafer), and a projection optical system 513 which projects the pattern of the original onto the substrate. The exposure apparatus can be configured to transfer the pattern of an original onto a substrate to form a latent image pattern on a photoresist applied on the substrate.

The substrate positioning mechanism 514 as an example of the positioning apparatus can include the above-mentioned plane pulse motor as a driving unit. More specifically, the substrate positioning mechanism 514 can include a fine moving stage mechanism which positions a substrate, and a coarse moving stage mechanism which positions the fine moving stage mechanism. The coarse moving stage mechanism can include a driving unit which drives the fine moving stage mechanism (and the substrate) as an example of the positioning target object, and the driving unit can include the above-mentioned plane pulse motor. That is, a mover of the coarse moving stage mechanism can include the mover according to the present invention described above, and a stator of the coarse moving stage mechanism can include the stator according to the present invention described above. The original positioning mechanism 511 can include the above-mentioned linear pulse motor as a driving unit.

A positioning apparatus as described above is not limited to a constituent component of an exposure apparatus, and can be put to practical use in order to position various types of objects.

The positioning apparatus can include herein a transport apparatus which transports an article.

A device manufacturing method according to a preferred embodiment of the present invention is suitable for manufacturing, for example, a semiconductor device and a liquid crystal device. The method can include a step of transferring the pattern of an original onto a photoresist applied on a substrate using the above-described exposure apparatus, and a step of developing the photoresist. The devices are manufactured by further other known steps (e.g., etching, resist removal, dicing, bonding, and packaging).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-132359, filed May 20, 2008, which is hereby incorporated by reference herein in its entirety.

What is claimed is:

1. A pulse motor which includes a first element in which a plurality of convex portions containing a magnetic material are arranged cyclically, and a second element disposed to face the first element, one of the first element and the second element being configured to function as a movable element and the other of the first element and the second element being configured to function as a stationary element, wherein
the plurality of convex portions include a plurality of first convex portions and a plurality of second convex portions, the first convex portion forming a part of a first magnetic circuit including a first portion which passes a magnetic flux along a first direction, and the second convex portion forming a part of a second magnetic circuit including a second portion which passes a magnetic flux along a second direction,
the second element includes a first coil to apply a magnetic flux to the first magnetic circuit, and a second coil to apply a magnetic flux to the second magnetic circuit, and
a time duration in which the movable element moves includes a time duration in which a timing at which a current flowing through the first coil is maximum and a timing at which a current flowing through the second coil is maximum appear alternately.

2. The motor according to claim 1, wherein
the second element includes a plurality of magnetic blocks having tooth tops facing the first element, and
the magnetic blocks apply the magnetic flux generated by the first coil to the first magnetic circuit, and apply the magnetic flux generated by the second coil to the second magnetic circuit.

3. The motor according to claim 2, wherein
the plurality of magnetic blocks include a first magnetic block, a second magnetic block, a third magnetic block, and a fourth magnetic block,
the first magnetic block and the second magnetic block are connected by a first connecting member containing a magnetic material, and are juxtaposed in the first direction,
the third magnetic block and the fourth magnetic block are connected by a second connecting member containing a magnetic material, and are juxtaposed in the first direction,
the first magnetic block and the third magnetic block are connected by a third connecting member containing a magnetic material, and are juxtaposed in the second direction,
the second magnetic block and the fourth magnetic block are connected by a fourth connecting member containing a magnetic material, and are juxtaposed in the second direction,
the first coil includes a coil wound around the first connecting member, and a coil wound around the second connecting member, and
the second coil includes a coil wound around the third connecting member, and a coil wound around the fourth connecting member.

4. The motor according to claim 1, wherein the first direction and the second direction are orthogonal to each other.

5. The motor according to claim 4, wherein each of the plurality of convex portions has a shape in which dimensions in the second direction thereof are different from each other at least at two positions on a straight line along the first direction.

6. The motor according to claim 4, wherein the plurality of first convex portions and the plurality of second convex portions are arranged in a checkerboard pattern.

7. The motor according to claim 1, wherein the first element includes an element which generates a thrust in the first direction, and an element which generates a thrust in the second direction.

8. The motor according to claim 1, wherein the first element functions as a stationary element, and the second element functions as a movable element.

9. The motor according to claim 1, wherein the first element functions as a movable element, and the second element functions as a stationary element.

10. A pulse motor which includes a first element and a second element disposed to face the first element, one of the first element and the second element being configured to function as a movable element and the other of the first element and the second element being configured to function as a stationary element, wherein
the first element includes a plurality of convex portions which are arranged cyclically and contain a magnetic material,
the plurality of convex portions include a plurality of first convex portions and a plurality of second convex portions, the first convex portion forming a part of a first magnetic circuit including a first portion which passes a magnetic flux along a first direction, and the second convex portion forming a part of a second magnetic circuit including a second portion which passes a magnetic flux along a second direction,
the first convex portions and the second convex portions include four first convex portions disposed around one second convex portion, and four second convex portions disposed around one first convex portion, and
the second element includes a first coil to apply a magnetic flux to the first magnetic circuit, a second coil to apply a magnetic flux to the second magnetic circuit, and a plurality of tooth tops which pass the magnetic fluxes generated by the first coil and the second coil.

11. A positioning apparatus which drives an object to position it by a driving unit comprising a pulse motor including a first element in which a plurality of convex portions containing a magnetic material are arranged cyclically, and a second element disposed to face the first element, one of the first element and the second element being configured to function as a movable element and the other of the first element and the second element being configured to function as a stationary element, wherein
the plurality of convex portions include a plurality of first convex portions and a plurality of second convex portions, the first convex portion forming a part of a first magnetic circuit including a first portion which passes a magnetic flux along a first direction, and the second convex portion forming a part of a second magnetic circuit including a second portion which passes a magnetic flux along a second direction,
the second element includes a first coil to apply a magnetic flux to the first magnetic circuit, and a second coil to apply a magnetic flux to the second magnetic circuit, and
a time duration in which the movable element moves includes a time duration in which a timing at which a current flowing through the first coil is maximum and a timing at which a current flowing through the second coil is maximum appear alternately.

12. An exposure apparatus which projects a pattern of an original onto a substrate to expose the substrate, the apparatus comprising:
a positioning apparatus which drives the substrate to position it by a driving unit; and
a projection optical system which projects the pattern of the original onto the substrate,
the driving unit comprising a pulse motor including a first element in which a plurality of convex portions containing a magnetic material are arranged cyclically, and a second element disposed to face the first element, one of the first element and the second element being configured to function as a movable element and the other of the first element and the second element being configured to function as a stationary element, wherein
the plurality of convex portions include a plurality of first convex portions and a plurality of second convex portions, the first convex portion forming a part of a first magnetic circuit including a first portion which passes a magnetic flux along a first direction, and the second convex portion forming a part of a second magnetic circuit including a second portion which passes a magnetic flux along a second direction,
the second element includes a first coil to apply a magnetic flux to the first magnetic circuit, and a second coil to apply a magnetic flux to the second magnetic circuit, and
a time duration in which the movable element moves includes a time duration in which a timing at which a current flowing through the first coil is maximum and a timing at which a current flowing through the second coil is maximum appear alternately.

13. A device manufacturing method comprising the steps of:
exposing a substrate using an exposure apparatus; and
developing the substrate,
wherein the exposure apparatus is configured to project a pattern of an original onto a substrate to expose the substrate and comprises:
a positioning apparatus which drives the substrate to position it by a driving unit; and
a projection optical system which projects the pattern of the original onto the substrate,
the driving unit comprising a pulse motor including a first element in which a plurality of convex portions containing a magnetic material are arranged cyclically, and a second element disposed to face the first element, one of the first element and the second element being configured to function as a movable element and the other of the first element and the second element being configured to function as a stationary element, wherein
the plurality of convex portions include a plurality of first convex portions and a plurality of second convex portions, the first convex portion forming a part of a first magnetic circuit including a first portion which passes a magnetic flux along a first direction, and the second convex portion forming a part of a second magnetic circuit including a second portion which passes a magnetic flux along a second direction,
the second element includes a first coil to apply a magnetic flux to the first magnetic circuit, and a second coil to apply a magnetic flux to the second magnetic circuit, and
a time duration in which the movable element moves includes a time duration in which a timing at which a current flowing through the first coil is maximum and a timing at which a current flowing through the second coil is maximum appear alternately.

14. A positioning apparatus which drives an object to position it by a driving unit comprising a pulse motor including a first element and a second element disposed to face the first element, one of the first element and the second element being configured to function as a movable element and the other of the first element and the second element being configured to function as a stationary element, wherein
the first element includes a plurality of convex portions which are arranged cyclically and contain a magnetic material,
the plurality of convex portions include a plurality of first convex portions and a plurality of second convex portions, the first convex portion forming a part of a first magnetic circuit including a first portion which passes a magnetic flux along a first direction, and the second convex portion forming a part of a second magnetic circuit including a second portion which passes a magnetic flux along a second direction,
the first convex portions and the second convex portions include four first convex portions disposed around one second convex portion, and four second convex portions disposed around one first convex portion, and
the second element includes a first coil to apply a magnetic flux to the first magnetic circuit, a second coil to apply a magnetic flux to the second magnetic circuit, and a plurality of tooth tops which pass the magnetic fluxes generated by the first coil and the second coil.

15. An exposure apparatus which projects a pattern of an original onto a substrate to expose the substrate, the apparatus comprising:
a positioning apparatus which drives the substrate to position it by a driving unit; and
a projection optical system which projects the pattern of the original onto the substrate,
the driving unit comprising a pulse motor including a first element and a second element disposed to face the first element, one of the first element and the second element being configured to function as a movable element and the other of the first element and the second element being configured to function as a stationary element, wherein
the first element includes a plurality of convex portions which are arranged cyclically and contain a magnetic material,
the plurality of convex portions include a plurality of first convex portions and a plurality of second convex portions, the first convex portion forming a part of a first magnetic circuit including a first portion which passes a magnetic flux along a first direction, and the second convex portion forming a part of a second magnetic circuit including a second portion which passes a magnetic flux along a second direction,
the first convex portions and the second convex portions include four first convex portions disposed around one second convex portion, and four second convex portions disposed around one first convex portion, and
the second element includes a first coil to apply a magnetic flux to the first magnetic circuit, a second coil to apply a magnetic flux to the second magnetic circuit, and a plurality of tooth tops which pass the magnetic fluxes generated by the first coil and the second coil.

16. A device manufacturing method comprising the steps of:
exposing a substrate using an exposure apparatus; and
developing the substrate,
wherein the exposure apparatus is configured to project a pattern of an original onto a substrate to expose the substrate and comprises:
a positioning apparatus which drives the substrate to position it by a driving unit; and
a projection optical system which projects the pattern of the original onto the substrate,
the driving unit comprising a pulse motor including a first element and a second element disposed to face the first element, one of the first element and the second element being configured to function as a movable element and the other of the first element and the second element being configured to function as a stationary element, wherein
the first element includes a plurality of convex portions which are arranged cyclically and contain a magnetic material,
the plurality of convex portions include a plurality of first convex portions and a plurality of second convex portions, the first convex portion forming a part of a first magnetic circuit including a first portion which passes a magnetic flux along a first direction, and the second convex portion forming a part of a second magnetic circuit including a second portion which passes a magnetic flux along a second direction,
the first convex portions and the second convex portions include four first convex portions disposed around one second convex portion, and four second convex portions disposed around one first convex portion, and
the second element includes a first coil to apply a magnetic flux to the first magnetic circuit, a second coil to apply a magnetic flux to the second magnetic circuit, and a plurality of tooth tops which pass the magnetic fluxes generated by the first coil and the second coil.
